(19) United States
(12) Patent Application Publication
(10) Pub. No.: US 2017/0016563 A1
(43) Pub. Date: Jan. 19, 2017

(54) INSULATED HOSE AND INSULATED HOSE COUPLING COVER

(71) Applicant: ALL-AMERICAN HOSE LLC, UNION CITY, PA (US)

(72) Inventors: MARSHALL B. HUNT, UNION CITY, PA (US); CALVIN TAN, GLASGOW (GB)

(73) Assignee: ALL-AMERICAN HOSE LLC, UNION CITY, PA (US)

(21) Appl. No.: 14/799,287

(22) Filed: Jul. 14, 2015

(51) Int. Cl. F16L 35/00; F16L 58/18; F16L 58/02; F16L 29/04; F16L 55/07

(52) U.S. Cl. CPC F16L 35/00; F16L 29/04; F16L 55/07; F16L 58/02; F16L 58/18

(57) ABSTRACT

The insulated hose coupling cover includes a first main collar, a first valve seat and a first valve. An insulated hose is also formed. The first passageway of the first main collar is aligned with the first passageway of the first valve seat. An actuator engages the first valve and moves the first valve with respect to the first valve seat between a first position and a second position. In the first position, the first passageway of the first valve is not aligned with the first passageway of the first main collar and the first passageway of the first valve seat. In the second position, the first passageway of the first valve is aligned with the first passageway of the first main collar and the first passageway of the first valve seat permits communication between an annular space and the first passageway of the first main collar.

### FIELD OF THE INVENTION

The invention is in the field of hose couplings and hoses which contain fluids which may freeze or partially freeze.

### BACKGROUND OF THE INVENTION

In connection with the transport of water and other fluids within hoses, the water is subject to freezing or partially freezing. This is especially true in fracking applications which require large amounts of water.

Rime ice is a white ice that forms under certain atmospheric conditions when the water droplets freeze to the outer surfaces of objects. Rime ice can form on hose coupling halves causing the coupling to freeze internally preventing the flow of water and other fluids therethrough. Rime ice is difficult to remove from coupling halves. Clear ice which appears homogeneous and transparent also forms on coupling halves under certain atmospheric conditions and is also difficult to remove from coupling halves.

### SUMMARY OF THE INVENTION

A hose coupling cover includes a first main collar. The first main collar includes a passageway therethrough. The first valve seat includes a first passageway therethrough. A first valve includes a first passageway therethrough. The first passageway of the first main collar is aligned with the first passageway of the first valve seat. An actuator bar engages the first valve and moves the first valve with respect to the first valve seat between a first position and a second position. In the first position, the first passageway of the first valve is not aligned with the first passageway of the first main collar and the first passageway of the first valve seat. The first hose coupling half, the first main collar, the first valve seat, and the first valve reside within the housing. The housing circumferentially extends about the first hose coupling half forming an annular space therebetween. The first passageway in the first valve seat communicates with the annular space between the first coupling half and the housing. In the second position, the first passageway of the first valve is aligned with the first passageway of the first main collar and the first passageway of the first valve seat thus permitting fluidic communication between the annular space and the first passageway of the first main coupling. The first passageway of the first main collar may communicate with a heat source. The first hose conveys fluid and is affixed to the first hose coupling half. The first outer shroud is affixed between the shroud collar and the first main collar. The first passageway of the first main collar communicates with an annulus formed by the first hose coupling half and the first cover coupling half.

The first hose collar affixes the first hose to the first hose coupling half and a first shroud collar affixes the first outer shroud to the first main collar. The housing includes a first cover half hinged to a second cover half.

The second main collar includes a first passageway therethrough. The second valve seat includes a first passageway therethrough. The second valve includes a first passageway therethrough. The first passageway of the second main collar is aligned with the first passageway of the second valve seat. The actuator engages the second valve and moves the second valve with respect to the second valve seat between a first position and a second position. In the first position, the first passageway of the second valve is not aligned with the first passageway of the second main collar and the first passageway of the second valve seat. The second main collar, the second valve seat, and the second valve reside within the housing. The first passageway in the second valve seat communicates with the annular space between the second valve seat, the second main collar, the second valve, the second coupling half and the housing. In the second position, the second passageway of the second valve is aligned with the first passageway of the second main collar, and the first passageway of the second valve seat permitting communication between the annular space and the passageway of the second main collar.

A hose coupling protection method, comprising the steps of: inserting a first hose through a first main collar, a first valve, a first valve seat, a first spacer and over an end of a first hose coupling half; positioning said first main collar against a first coupling cover half or a second coupling half; securing the first hose to the end of the first hose coupling half and urging the spacer and the valve seat against the first main collar using a first hose collar; positioning a first hose shroud within a first coupling cover half and over the first main collar securing the first hose shroud to the main first collar using a first shroud collar; forming a first annulus between the first hose shroud and the first hose; closing the first coupling cover half and the second coupling half together forming a housing annulus between the first hose coupling half and the first and second coupling cover halves; and, enabling communication between the first annulus and the housing annulus.

An object of the invention is to provide insulation for the hose couplings to prevent them and their contents from freezing or partially freezing.

Another object of the present invention is to provide an external hose jacket (hose shroud) for insulating the hose and prevent the hose and its contents from freezing.

Another object of the present invention is to provide insulation for hose couplings and hoses connected to the hose couplings.

Another object of the present invention is to provide heated air to the full length of a fracking hose including hose coupling which reside intermediate hose sections.

Another object of the present invention is to provide insulated sections of hose connected together with insulated hose couplings.

Another object of the present invention is to provide air transit capability to enable passage of hot air through sections of hose and couplings connected to them.

Another object of the present invention is to interconnect a heat source to the annulus between the hose shroud and the hose so as to prevent the hose and its contents from freezing.

Another object of the present invention is to interconnect a heat source to the housing annulus between the coupling cover and the coupling so as to prevent the coupling and its contents from freezing.

### BRIEF DESCRIPTION OF THE DRAWINGS

FIG. 1 is a perspective view of the first and second hoses within the hose coupling cover with the pivoting handle and the catcher unlatched.

FIG. 1A is a left side view of the first hose within the hose coupling cover.

FIG. 1B is a cross-sectional view taken along the lines 1B-1B of FIG. 1.

FIG. 1C is a perspective view of the first hose, the first and second hose shrouds, the first hose coupling half, the second hose coupling half, and the actuator system.

FIG. 1D is a rear view of the first and second hose shrouds, the first hose coupling half, the second hose coupling half, the actuator system, including the catcher which engages the actuator system.

FIG. 1E is an enlargement of a portion of FIG. 1B illustrating passageways in the first main collar and passageways in the valve seat blocked by the first valve.

FIG. 1F is a left side view of the first hose, the first valve seat, the first valve, and the actuator system including the catcher which engages the actuator system wherein the first valve is in the first position.

FIG. 1G is another perspective view of the first and second hoses, the first hose coupling half, the second hose coupling half, the first valve seat, the first valve, the second valve seat, and the actuator system including the catcher which engages the actuator system.

FIG. 1H is an enlarged perspective view of the first hose, the first valve seat, the first valve, and the actuator system including the catcher which engages the actuator system.

FIG. 1I is a left side view of the first hose, the first valve seat, the first valve, the actuator system including the catcher which engages the actuator system wherein the first valve is in the second position.

FIG. 2 is a view of the inner portion of one of the cover halves.

FIG. 2A is a view of the outer portion of one of the cover halves.

FIG. 2B is a view of the outer portion of the other cover half.

FIG. 2C is a view of the inner portion of the other cover half.

FIG. 3 is a perspective view of the first main collar.

FIG. 3A is a cross sectional view of the first main collar taken along the lines 3A-3A of FIG. 3.

FIG. 3B is a perspective view of the first valve.

FIG. 3C is a perspective view of the first valve seat.

FIG. 3D is an exploded perspective view of the first main collar, first valve and the first valve seat.

FIG. 4 is a perspective view of the first and second hoses within the hose coupling cover with the pivoting handle and the catcher latched.

FIG. 4A is a cross-sectional view taken along the lines 4A-4A of FIG. 4.

FIG. 4B is an enlargement of a portion of FIG. 4A illustrating passageways in the first main collar and passageways in the valve seat communicating through a passageway through the first valve.

FIG. 5 is a perspective view of the coupling cover halves with the placement of the coupling halves, hoses, hose shrouds, collars and other components therein and before the coupling cover halves are closed.

### DESCRIPTION OF THE INVENTION

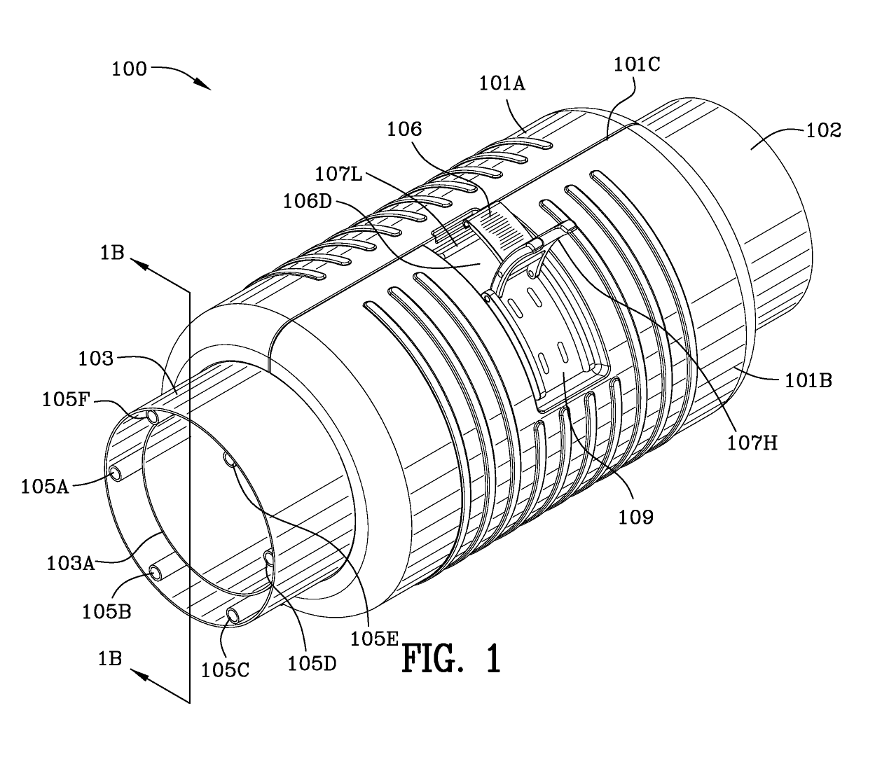

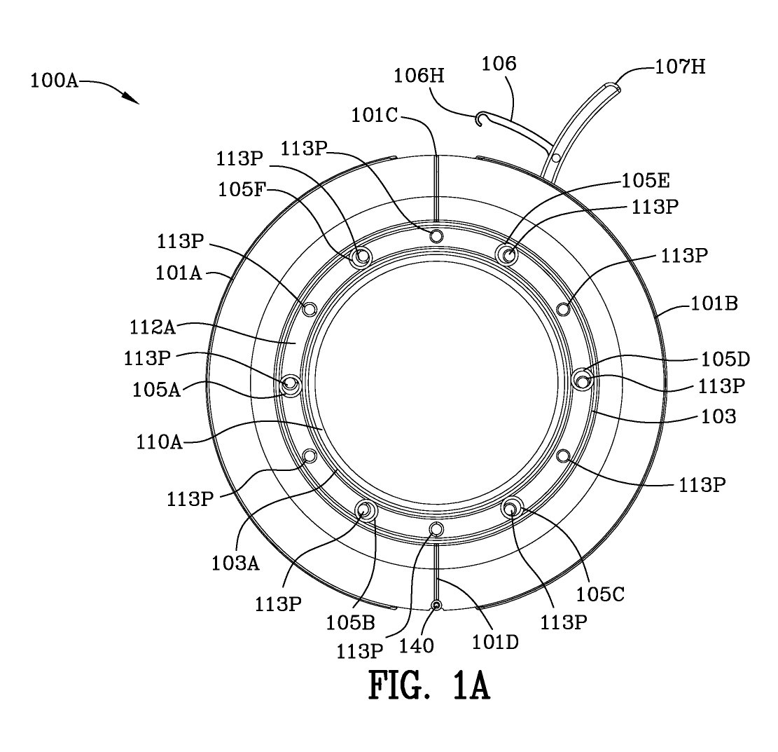

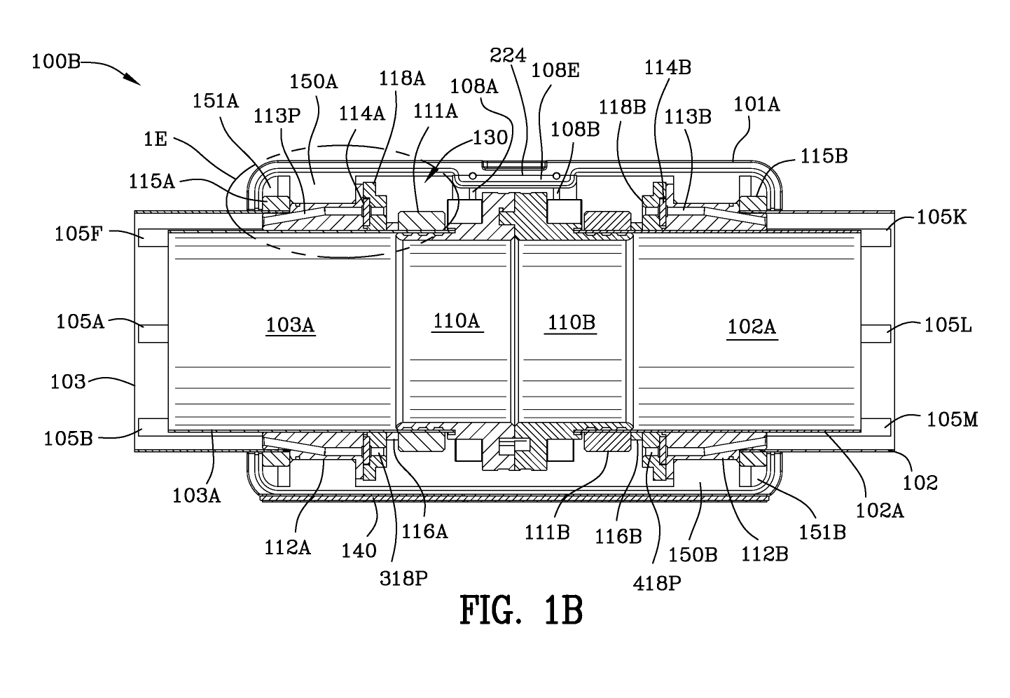

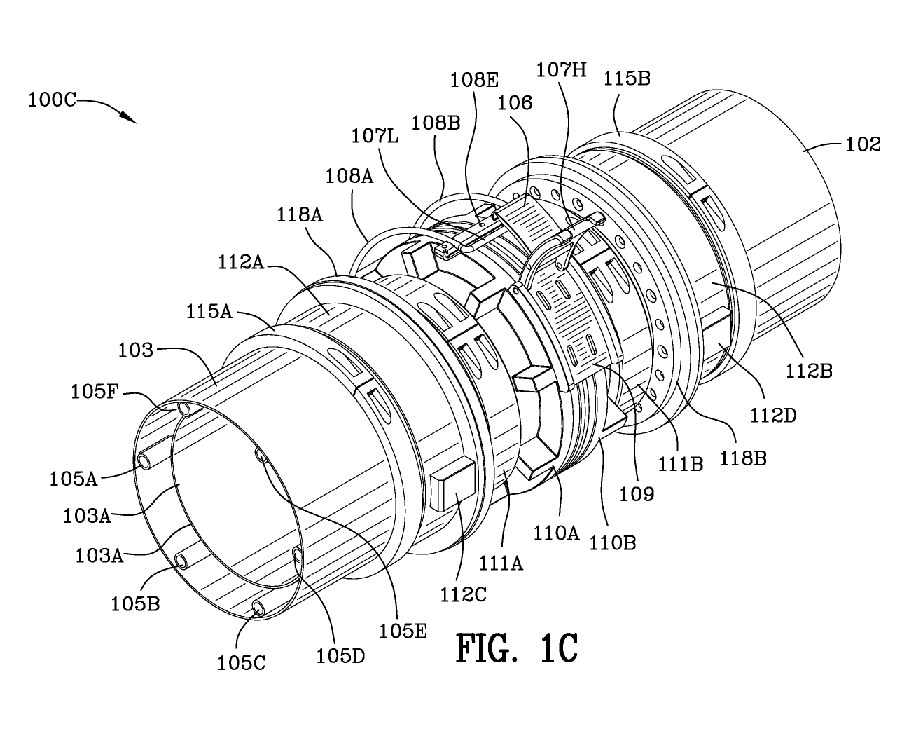

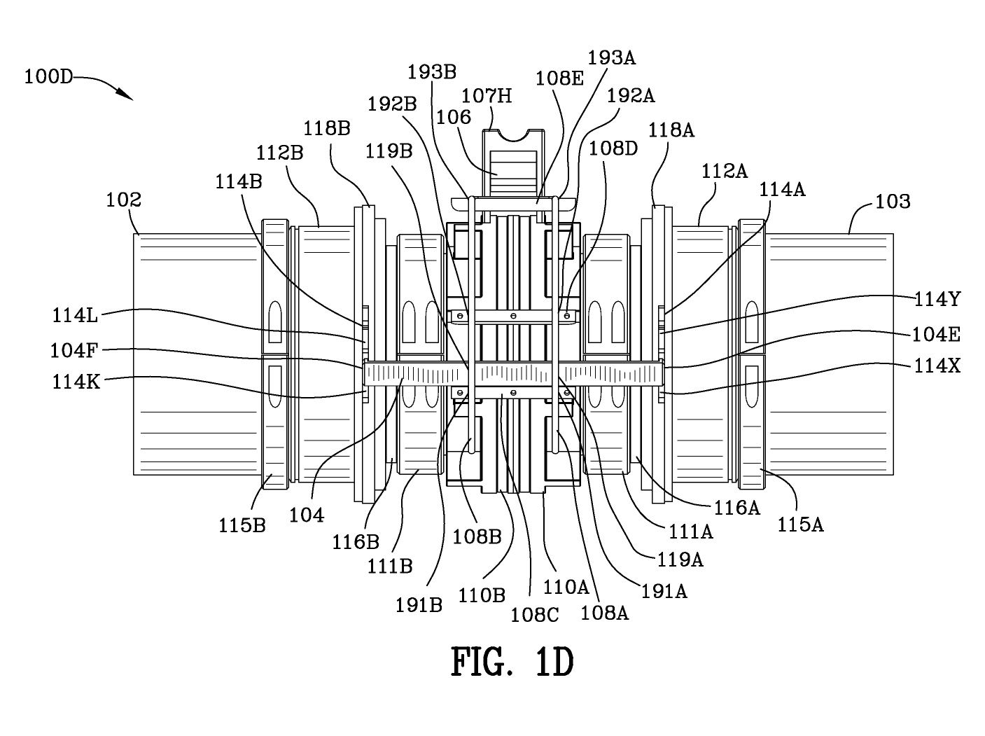

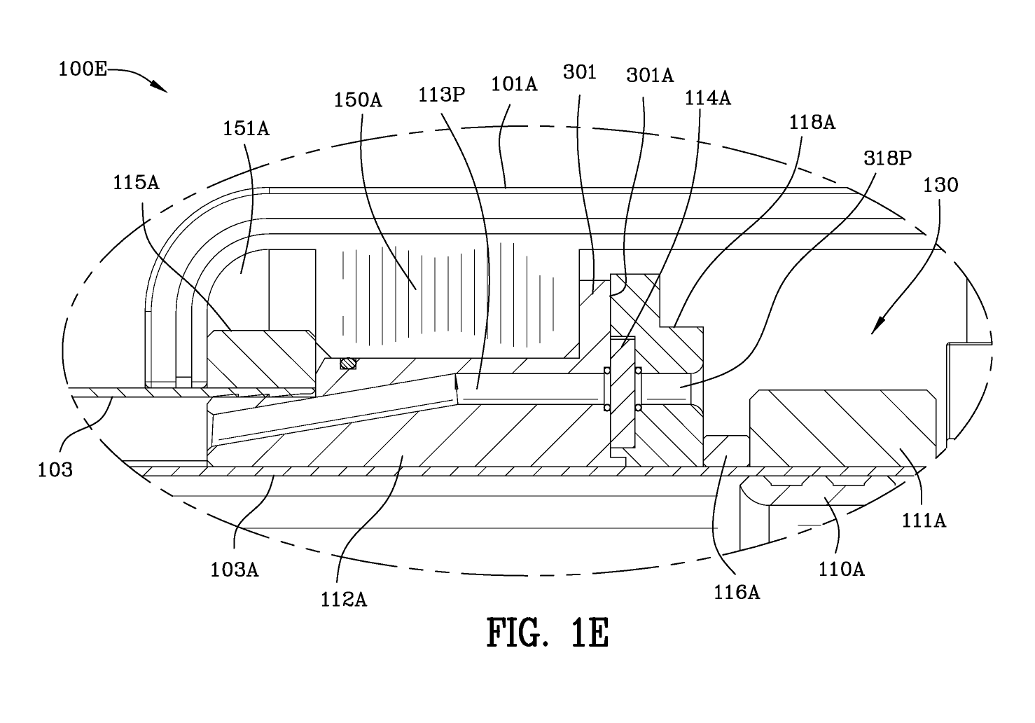

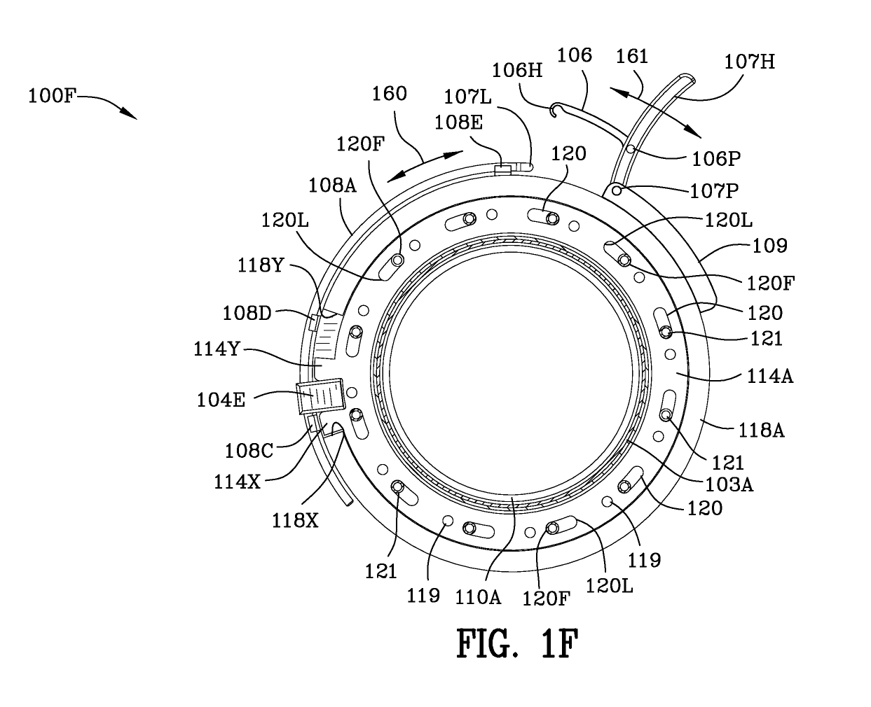

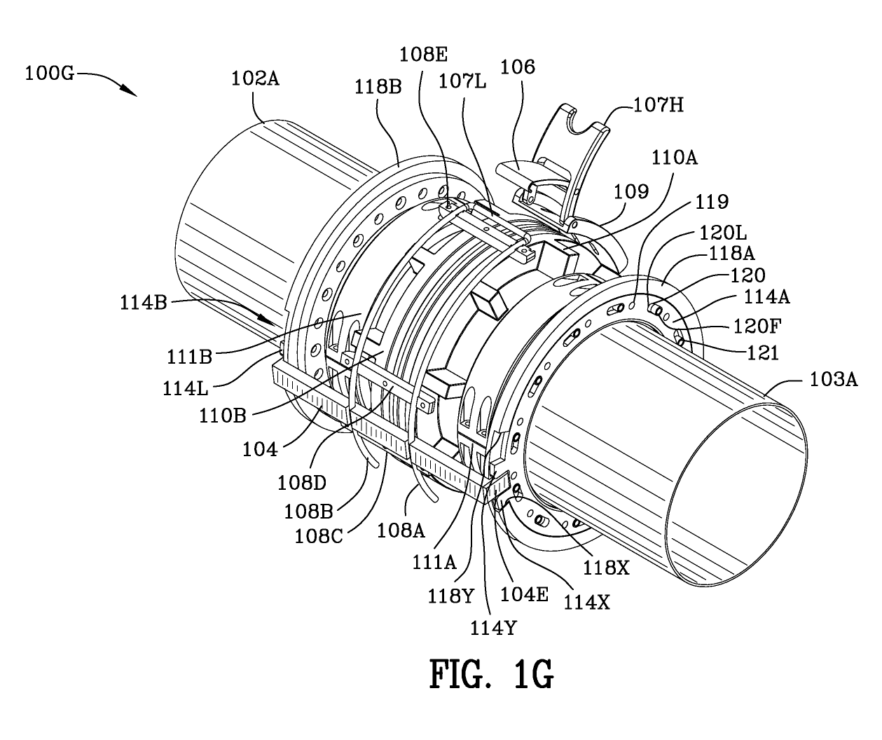

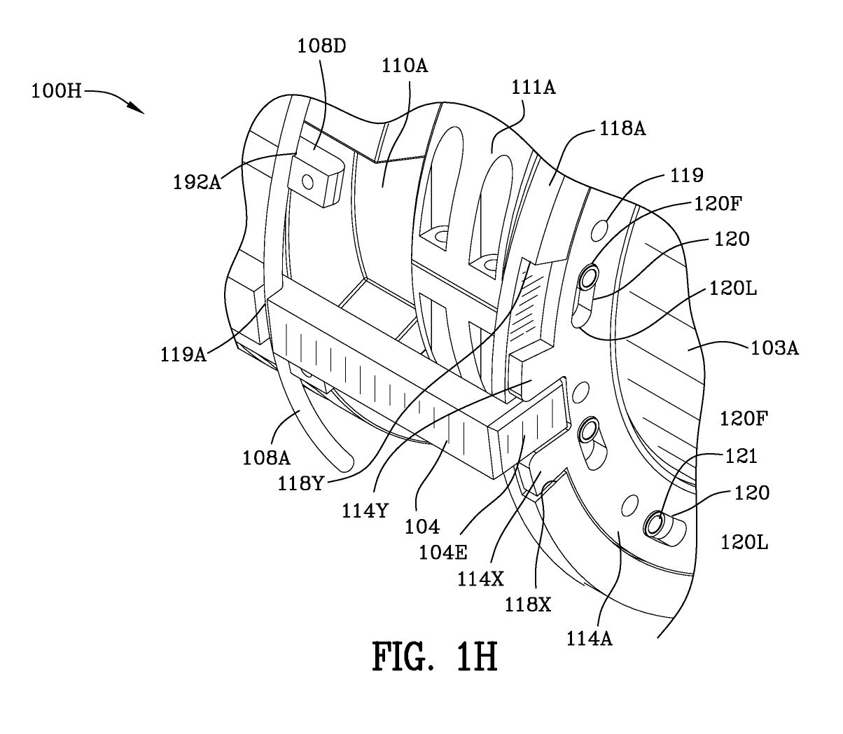

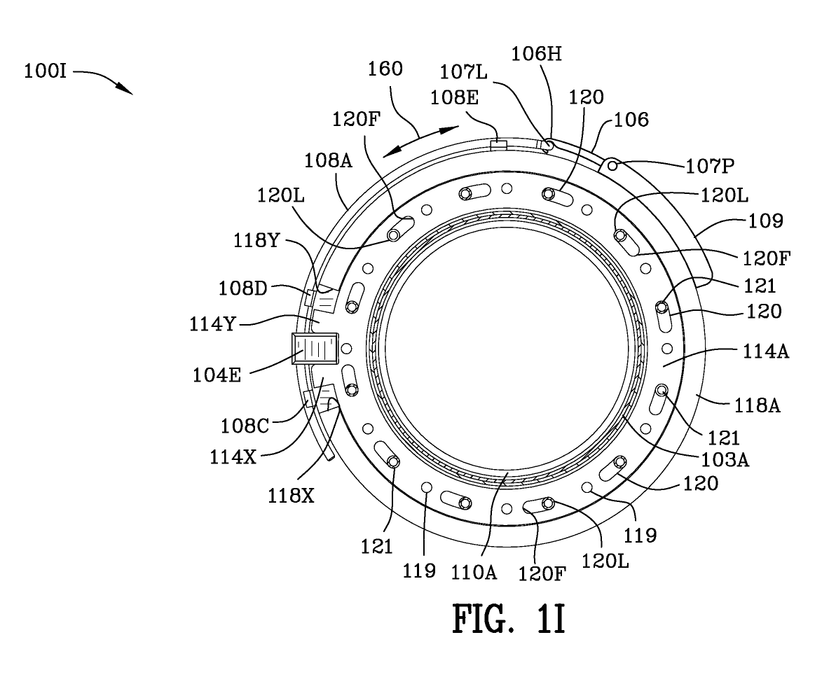

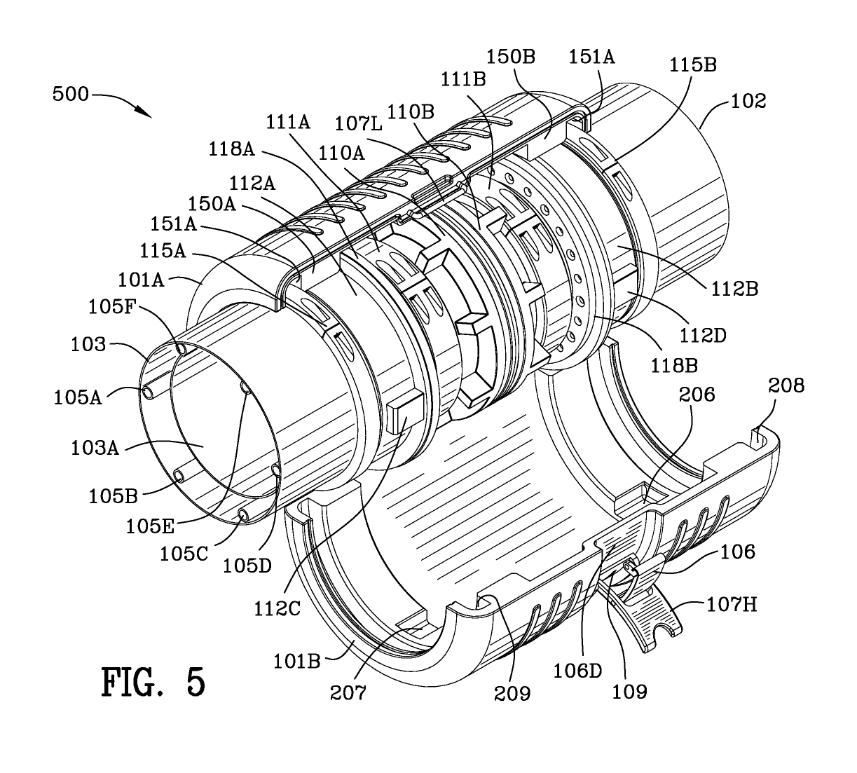

FIG. 1 is a perspective view 100 of the first and second hoses 103A, 102A within the hose coupling cover 101A, 101B. The hoses 103A, 102A may be six, eight, ten or twelve inches in diameter. The hoses and hose shrouds may be hundreds of feet long, Virtually, any diameter hose may be used. The coupling cover includes a first coupling cover half 101A and a second coupling cover half 101B which are separated by a seam 101C when the coupling cover halves 101A, 101B are closed together as shown in FIG. 1. Coupling cover halves 101A, 101B are opened and closed like a brief case is opened and closed. When the coupling cover halves are opened the coupling halves 110A, 110B, the hoses 103A, 102A and associated collars and spacers are placed therein. See FIG. 5.

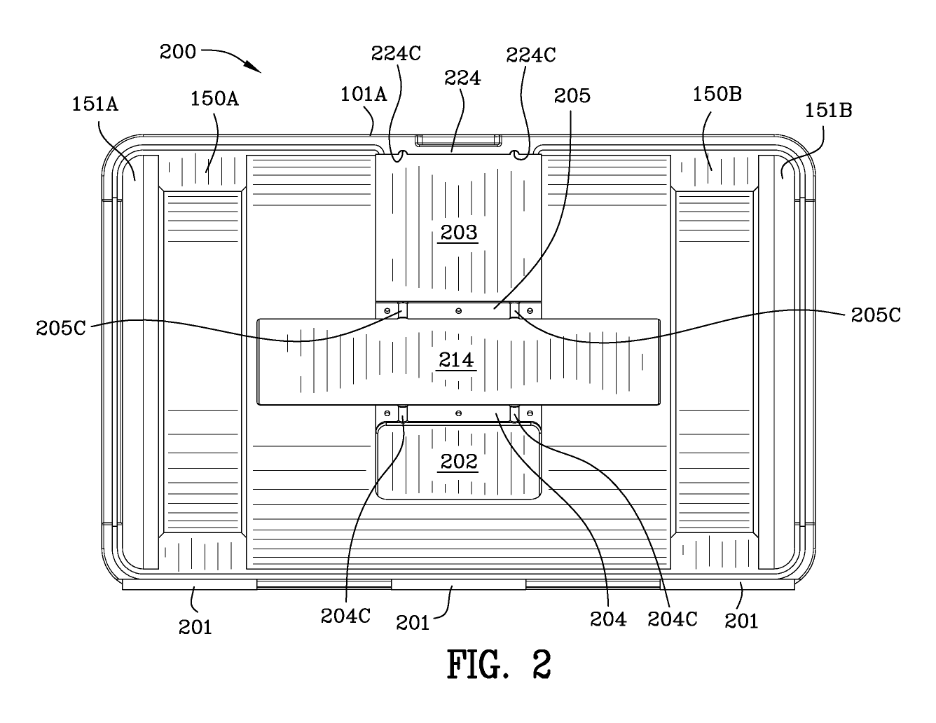

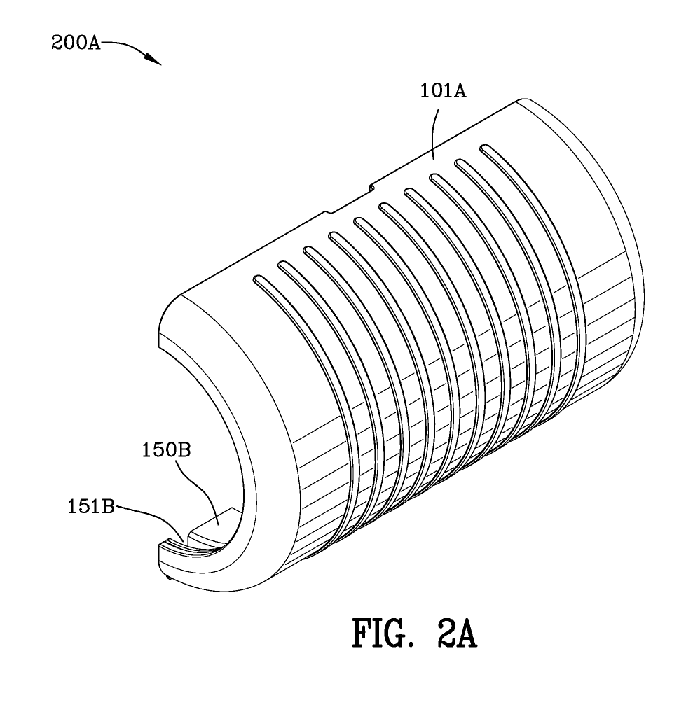

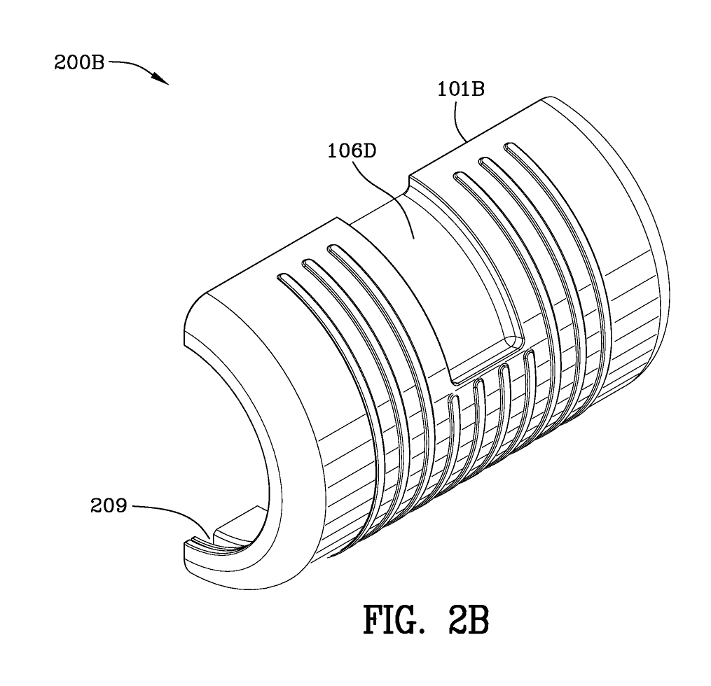

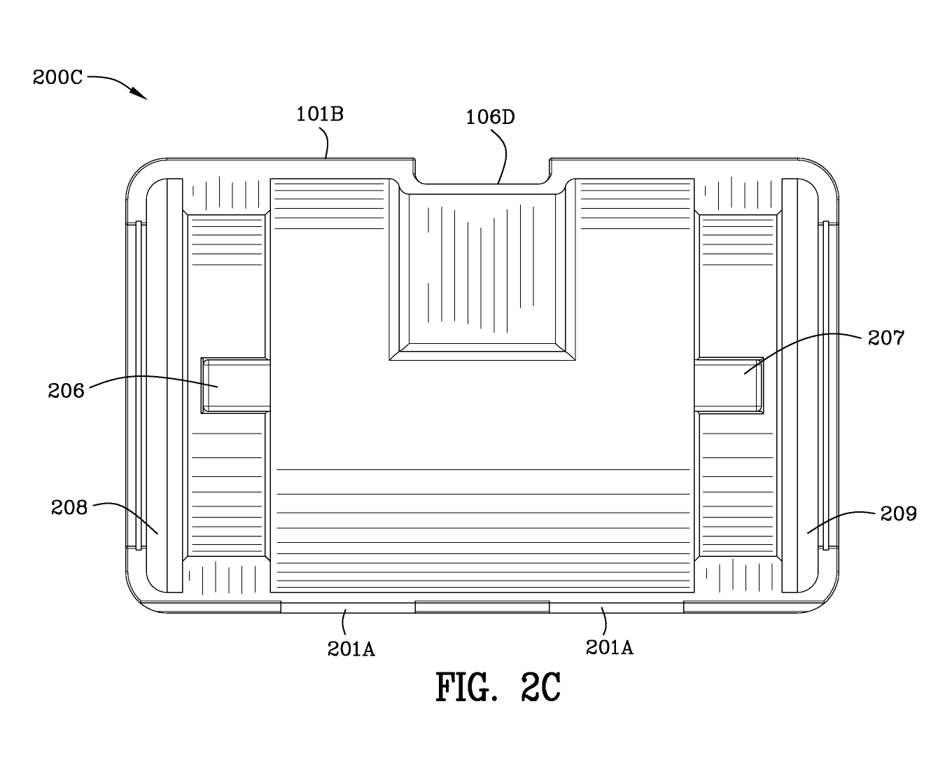

FIGS. 2, 2A, 2B and 2C illustrate the coupling cover halves 101A, 101B. Coupling cover halves 101A, 101B engages the shroud collars 115A, 115B and the main collars 112A, 112B. Valve seats 118A, 118B enclose respective rotatable valves 114A, 114B and are secured to respective main collars 112A, 112B. Preferably, the valves 114A, 114B are made of stainless steel. Preferably, the first and second main collar 112A, 112B are made of nylon. Preferably, valve seats 118A, 118B are made of nylon. However, other materials are specifically contemplated for the main collars, the valves and the valve seats.

The instant description is made primarily in regard to the main collar valve 112A, rotatable valve 114A, valve seat 118A, first hose collar 111A, first shroud collar 115A, first spacer 116A, first hose 103A, first shroud 103, and the first hose coupling half 110A. The descriptions in regard to the aforesaid elements are equally applicable to the main collar valve 112B, rotatable valve 114B, valve seat 118B, first hose collar 111B, first shroud collar 115B, first spacer 116B, first hose 103B, first shroud 102, and first hose coupling half 110B.

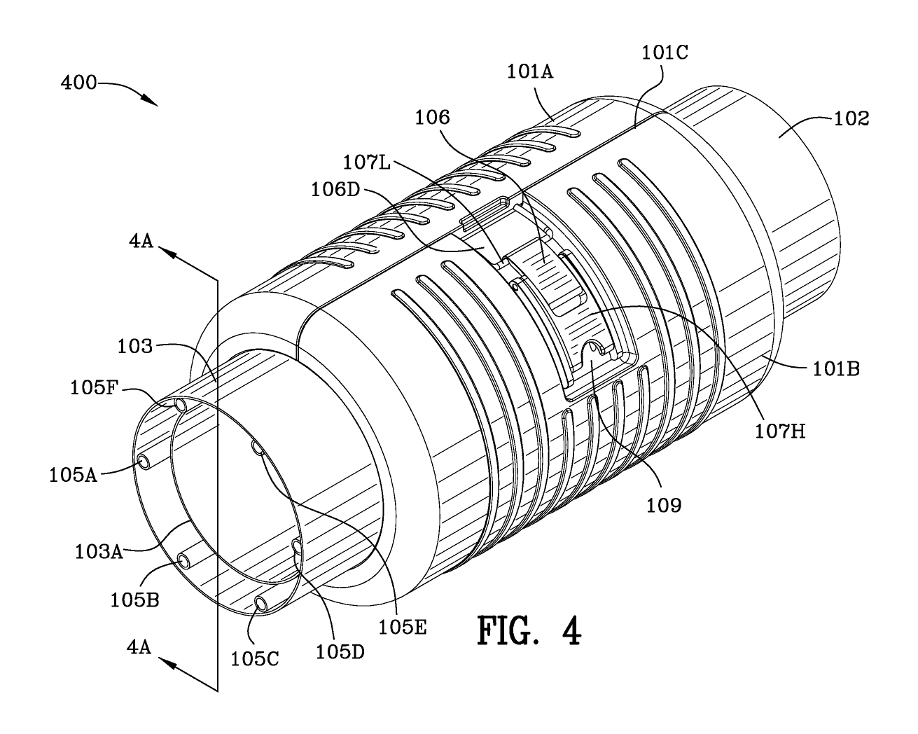

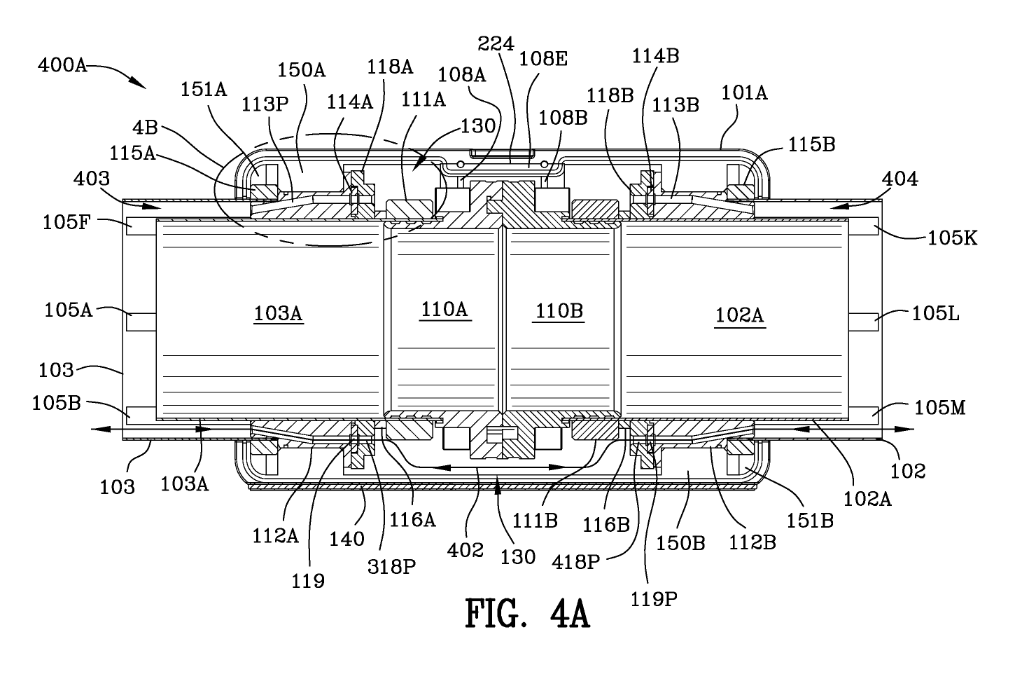

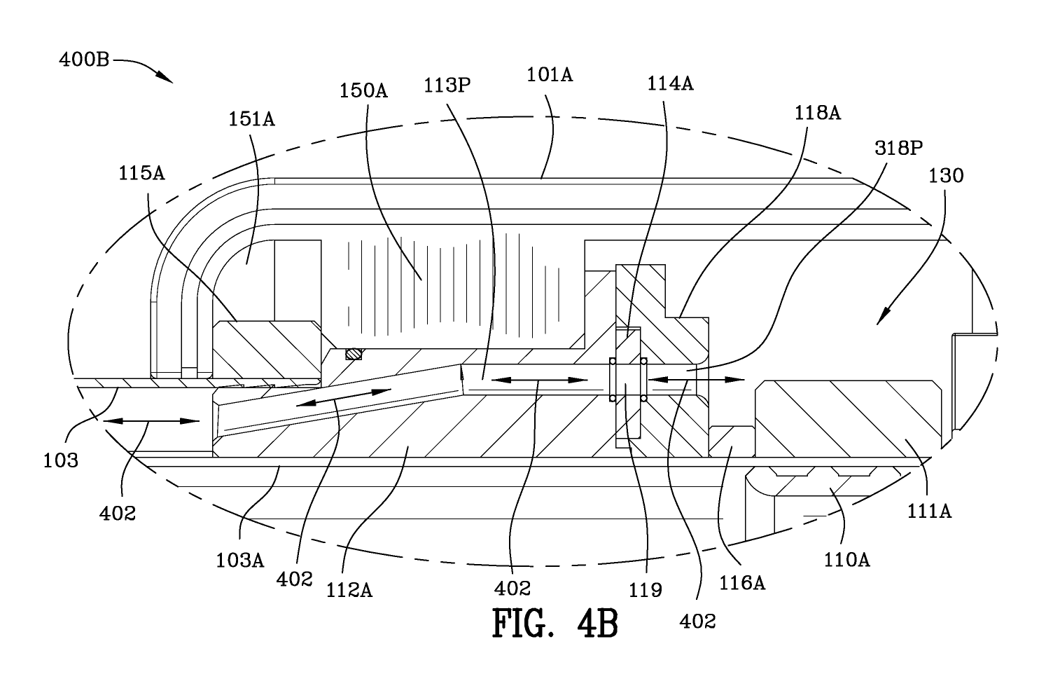

The first coupling cover half 101A is hinged to the second coupling cover half 101B as illustrated at the bottom of FIGS. 1A and 1B. Hook 106H of catcher 106 engages bar actuation linkage 107L and moves the linkage between a first position (open position) and a second position (closed position). Preferably the handle (clamp) is made of plastic, however, other materials may be used. Plate 109 is secured to coupling cover half 101B. Handle 107H snap-locks into place as illustrated in FIG. 4. Plate 109 is preferably made of aluminum, however, other materials may be used. Plate 109, catch 106H and a portion of the linkage 106L reside in cavity 106D. FIG. 1 also illustrates hose shrouds 103, 102 and hose 103. Hose 103A is spaced apart from hose shroud 103 using spacer pipes 105A, 105B, and 105C. A heat source (not shown) may be connected between the hose 103 and the hose shroud 103A. The heat source may be located between coupling cover halves and adapted to pass through the hose shroud and into the annulus between the hose shroud and the hose. The heat source that supplies the annulus between the hose shroud and the hose may also be used to heat the housing annulus between the coupling cover halves and the coupling. The heat is communicated through the passageway 113P of the main collar 112A, the passageway 119 of the valve 114A, and the passageway 318P of the valve seat 118A when the passageway 119 of the valve is aligned with the passageway 113P of the main collar and the passageway 318P of the valve seat 114A in the second position of the valve 114A with respect to the valve seat 118A. See FIGS. 4, 4A and 4B which illustrate the second position of the valves 114A, 114B with respect to the valve seats 118A, 118B.

FIG. 1A is a left side view 100A of the first hose 103A within the hose coupling cover halves 101A, 101B. Passageways 113P are shown in the end of the main collar 112A. Passageways 113P run completely through the main collar 112A. The end of coupling half 110A is also illustrated in FIG. 1A and hose 103A is secured by the coupling half 110A and first hose collar 111A as illustrated in FIG. 1B. Tubes or pipes 105A, 105B, 105C, 105D, 105E, and 105F support and separate the hose shroud 103 with respect to the hose 103A. Instead of using the terms tubes or pipes, the term spacers could be used instead. The geometry of the spacers does not have to be circular in cross-section or cylindrical. Rather, the spacers could have a triangular in cross-section shape or any other shape that effectively radially separates the hose shroud from the hose. The materials of the spacers could be metal or plastic or a combination of metal and plastic. Spacers 105A, 105B, 105C, 105D, 105E, and 105F as illustrated in the drawing FIGS. 1, 1A, 1B etc. appear short in length. However, the spacers may be long in length as the hoses 103A, 102A extend hundreds of feet. A typical lay flat, polyurethane hose is 660 feet in length. Different length hoses (other than 660 feet in length) may be used and the hoses may be joined together by couplings. Sections (lengths) of hose may be connected together and extend for lengths in excess of one mile. The hoses, when filled, assume the cylindrical shape depicted in the drawing figures. Additionally the spacers 105A, 105B, 105C, 105D, 105E, and 105F may be discontinuous and/or they may be designed in pattern differently than as shown herein in the drawings. In other words, there may be more or fewer spacers and the length of one spacer may be different than the length of the next adjacent spacer. The spacers may also be supported by a clip or other retainer in the annulus between the hose shroud and the hose so as to support the spacers and to keep them in position. Hose 103A may be any type of hose used in the fracking industry or any type of hose used in cold weather for a variety of applications.

Still referring to FIG. 1A, seams 101C, 101D are illustrated between the coupling halves 101A, 101B. Hinge rod 140 is illustrated at the bottom of FIG. 1A. Each of the coupling cover halves includes hinges at the bottom thereof. Hinges 201 are shown at the bottom of coupling cover half 101A. See FIG. 2. Hinges 201A are shown at the bottom of coupling cover half 101B. See FIG. 2C.

FIG. 1B is a cross-sectional view 100B taken along the lines 1B-1B of FIG. 1A. FIG. 1B illustrates the first shroud collar 115A for securing the hose shroud 103 to the first main collar 112A. FIG. 1B illustrates the first hose collar 111A securing the hose 103A to the coupling half 110A. Shroud collars 115A, 115B and hose collars 111A, 111B are tightened using screws.

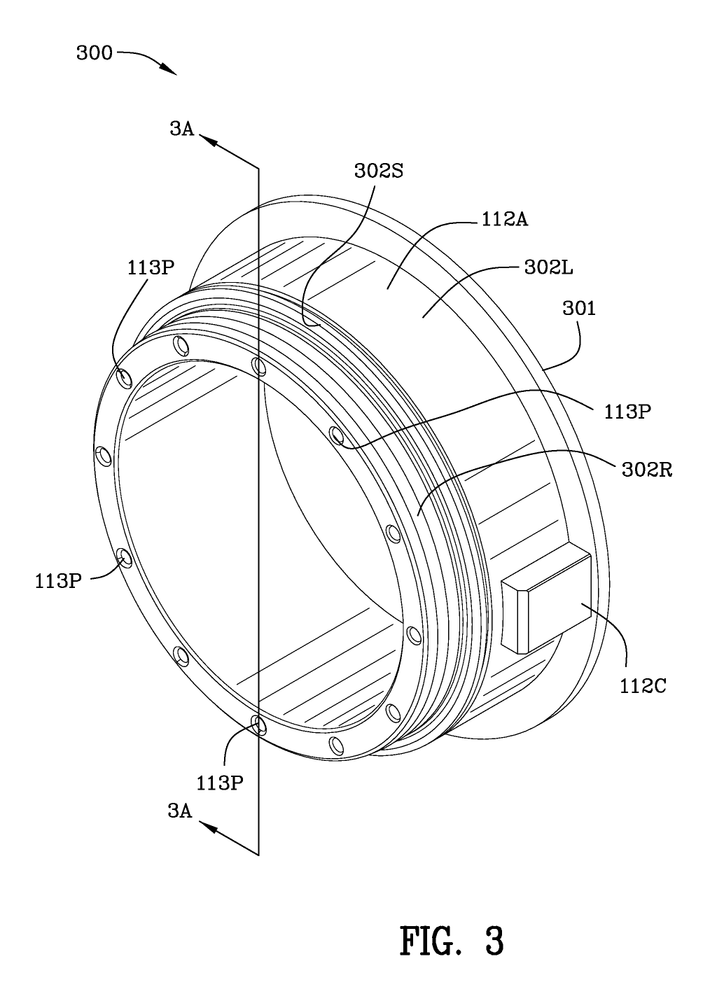

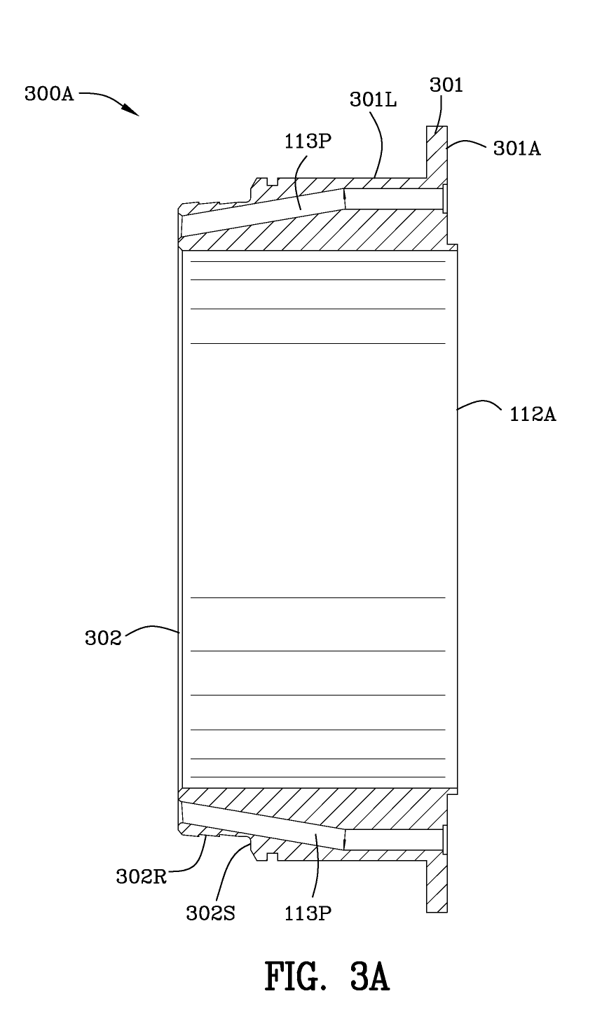

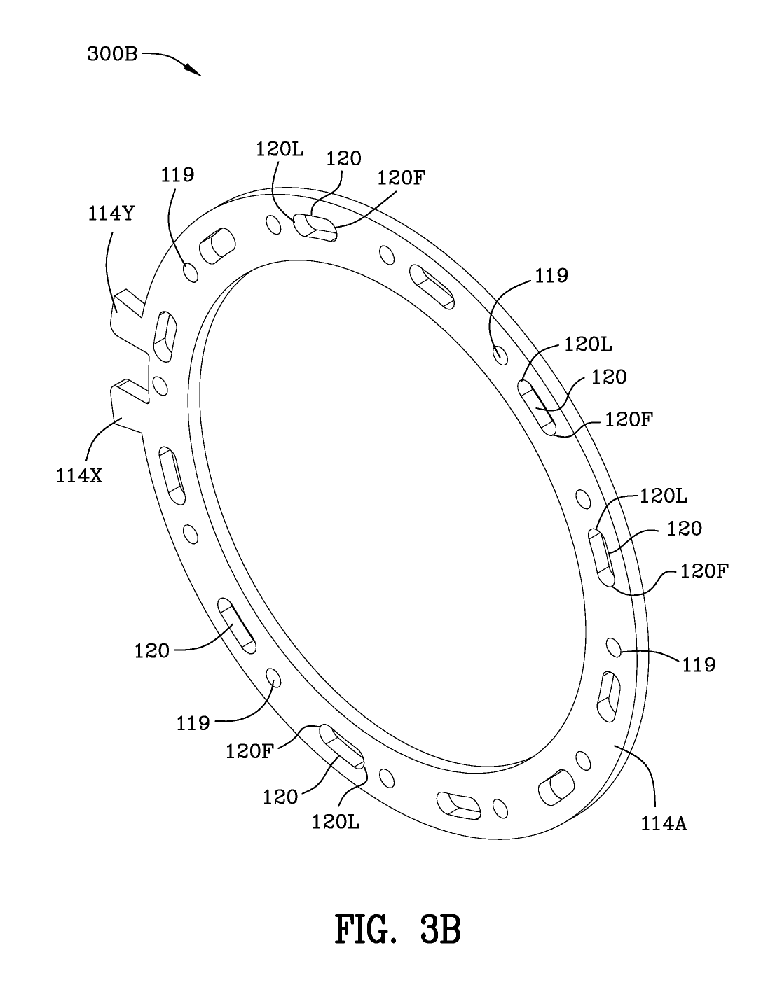

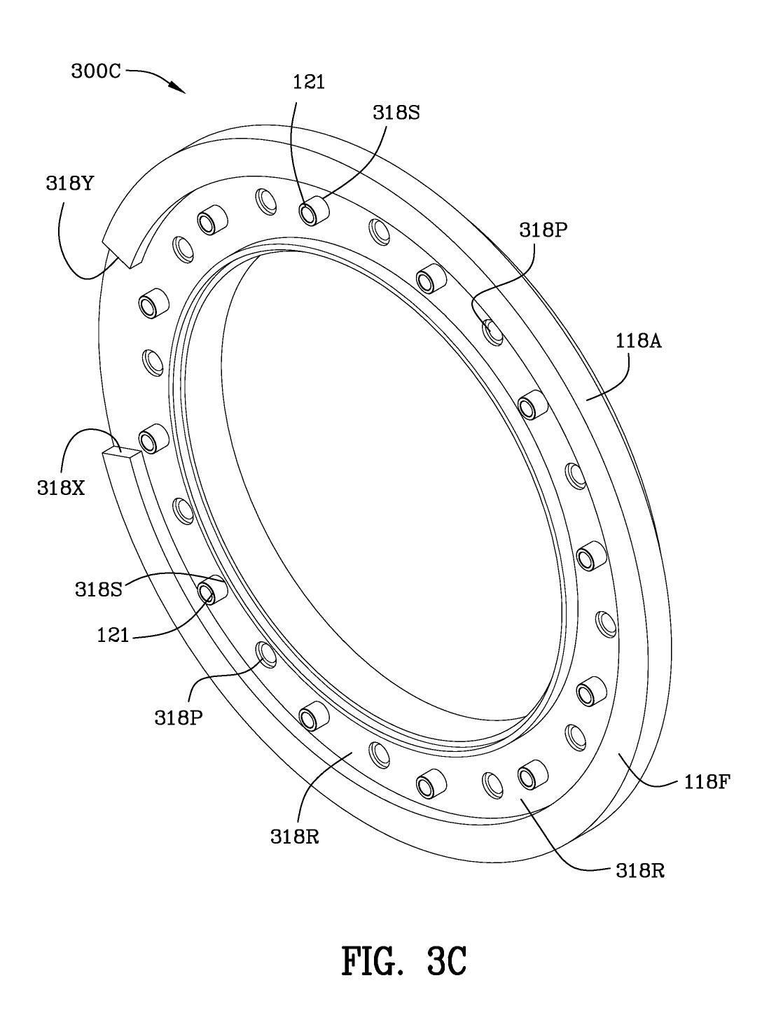

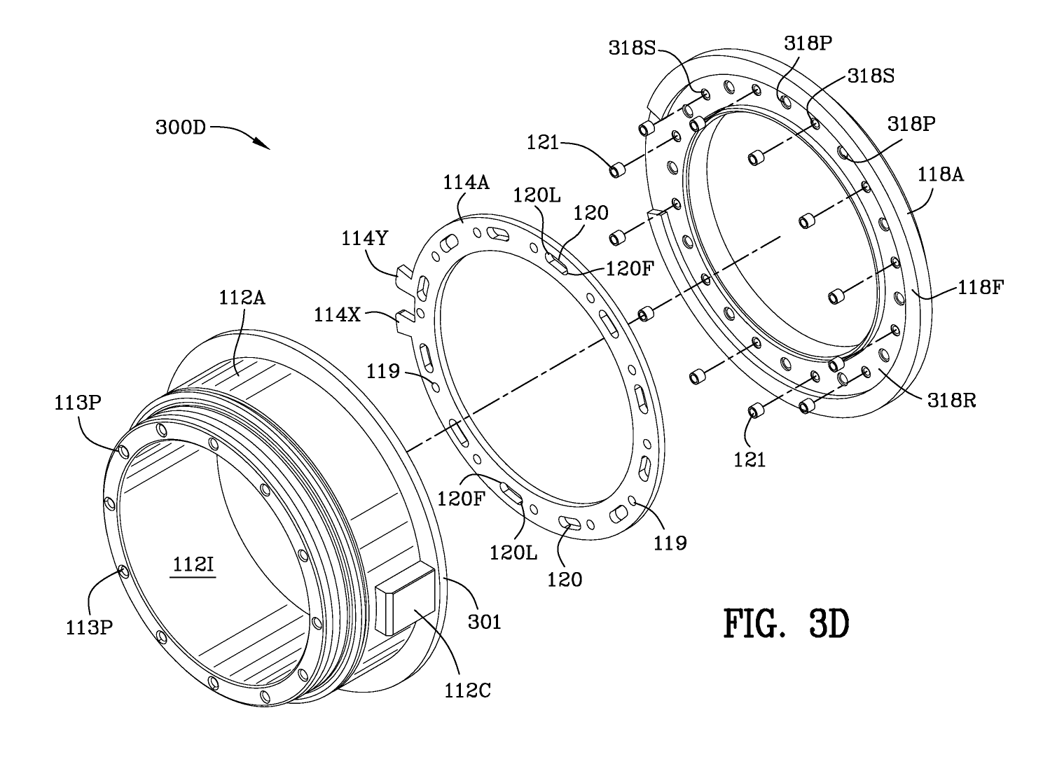

Still referring to FIG. 1B, the first shroud collar 115A resides partially within space/cavity 151A adjacent guide 150A. Main collar 112A includes a lip portion 301 which abuts guide 150A. FIG. 3 is a perspective view 300 of the first main collar 112A. Second main collar 112B is identical to first main collar 112A but it is oriented differently. FIG. 3 illustrates a plurality of passageways 113P from the end of the first main collar 112A that is seen in FIG. 1A. Passageways 113P are also viewed in FIGS. 1B and 1E. First main collar 112A includes a reduced diametrical surface 302R, a shoulder 302S, a larger diametrical surface 302L, a lip 301 and a locking block 112C. Locking block 112C interfits with a reciprocally shaped recess 206 in the coupling cover half 101B as illustrated in FIG. 2C. Locking block 112C prevents rotation of the main collar 112A, the shroud locking collar 115A, and the valve seat 118A. Locking block 112D illustrated in FIG. 1C prevents rotation of the main collar 112B, the shroud locking collar 115B, and the valve seat 118B. Locking block 112D interfits with a reciprocally shaped recess 207 in the coupling cover half 101B as illustrated in FIG. 2C.

FIG. 3A is a cross sectional view 300 of the first main collar 112A taken along the lines 3A-3A of FIG. 3 illustrating passageways 113P therethrough. Passageways 113P communicate with the passageways 119 shown in FIG. 3B. Slots 120 in the valve 114A are guided by guide pins 121 as the actuator bar 104 rotatably moves the valve 114A with respect to the valve seat 118A. Preferably, the actuator bar 104 is made of stainless steel. Referring to FIGS. 3A and 1H, valve 114A includes protrusions 114X, 114Y which are spaced apart from one another. Extension 104E of actuator bar 104 resides between the protrusions 114X, 114Y and rotatably moves the valve 114A between a first position (closed position) as illustrated in FIG. 1H and a second position (open position) as illustrated in FIG. 1I. FIGS. 4, 4A and 4B illustrates, in cross-section, the second position of the valve 114A with the passageways 113P of the main collar aligned with the passageways 119 of the valve and the passageways 318P of the valve seat. See FIGS. 1E, 1H, 3, 3A, 3B, and 3C.

FIG. 3B is a perspective view 300B of the first valve 118A. Referring to FIGS. 3C and 1H, first valve 118A includes a first shoulder 118X and a second shoulder 118Y. When protrusions 114X, 114Y are in the first position, protrusion 114X is adjacent first shoulder 318X. When protrusions 114X, 114Y are in the second position, protrusion 114Y is rotated clockwise and the passageways 119 of valve 114A align with the passageways 113P of the first main collar 114A and the passageways 318P of the valve seat 118A.

FIG. 3C is a perspective view 300C of the first valve seat 118A. First valve seat 118A includes a face 118F which engages lip 301 of the first main collar valve 112A. A recess 318R receives rotatable first valve 114. Protrusion 114X engages first shoulder 318X of the valve seat when the extension 104E of the actuator 104 is in the first position prohibiting communication between passageways 113P of the first main collar 112A and the passageways 318P of the first valve seat 118A. In the second position of the actuator 104, as illustrated in FIGS. 4, 4A and 4B, the actuator is rotated clockwise such that the passageways 119 of valve 114A align with the passageways 113P of the first main collar 112A and the passageways 318P of the valve seat 118A enabling communication between passageways 113P of the first main collar 112A and the passageways 318P of the first valve seat. Guide pins 121 reside in correspondingly sized pin sockets 318S and in guide valve 114A. Guide pins 121 reside in slots 120 best viewed in FIG. 1H. Slots 120 include a first end 120F and a second end 120L. In the first position of the valve as set forth in FIG. 1F, guide pins 121 reside in engagement with the first end 120F of the slot 120 as the bar actuation linkage 107L has been pushed by the hook 106H or by the hand of the operator. When the cover coupling halves are closed, the operator connects linkage 106H to the bar actuation linkage 107L and rotates the handle 107H in a downward, clockwise motion as viewed in FIG. 1F. The rotation of the handle 107H pulls the catcher 106 and the bar actuation linkage 107L to the position illustrated in FIG. 4 rotating the first valve 114A in the clockwise direction when viewed in FIG. 1F. FIG. 1I illustrates the first valve 114A in the second position thus allowing communication between passageways 113P of the first main collar, the passageways 119 of the first valve, and the passageways 318P as best viewed in FIG. 4B. See FIGS. 4, 4A, 4B and FIG. 1I.

FIG. 3D is an exploded perspective view 300D of the first main collar 112A, first valve 114A and the first valve seat 118A. Guide pins 121 are inserted into correspondingly sized pin sockets 318S in first valve seat 118A. Pin sockets 318S are arranged between passageways 318P in the first valve seat 118A. Guide pins 121 are supported in pin sockets 318S and abut the main collar 112A. Guide pins 121 extend into respective slots 120 in the first valve 114A. First valve seat 118A is stationary and does not rotate with respect to the first main collar 112A. First valve 114A rotates between first and second positions within the valve seat 118A. The first position of the first valve 112A is illustrated in FIG. 1F and the second position of the first valve is illustrated in FIG. 1I. In the first position as illustrated in FIG. 1F, the first end 120F of the slots abut the guide pins 121 and the second end 120L of the slots 120 abut the guide pins 121 as the first valve is rotated in the clockwise direction to the second position as illustrated in FIG. 1I. When the first valve is rotated until guide pins 121 abut the second end 120L of the slots, passageways 119 are aligned with passageways 113P, 318P.

Referring to FIGS. 1D, 1F, and 1G, actuator extensions 104E, 104F move first and second valves 114A, 114B, respectively, in a clockwise direction when viewed from the perspective of FIG. 1F. When viewed from the perspective of FIGS. 1D and 1G, actuator bar 104 is rotated upwardly and actuator extensions 104E, 104F engage, respectively, protrusions 114Y, 114L on first and second valves 114A, 114B.

FIG. 4 is a perspective view 400 of the first and second hoses 103A, 102A within the hose coupling cover halves 101A, 101B with the pivoting handle 107H and the catcher 106 latched. With the pivoting handle 107H and the catcher 106 latched, the actuator 104 is in the second position as illustrated in FIG. 1I and the first and second valves 114A, 114B are in the second position permitting communication between annuluses 403, 404 as illustrated in FIG. 4A. FIG. 4A is a cross-sectional view 400A taken along the lines 4A-4A of FIG. 4. The annuluses 403, 404 may be hundreds of feet in length. Annulus 403 is formed between hose shroud 103 and hose 103A Annulus 404 is formed between hose shroud 102 and hose 102A.

Still referring to FIG. 4A, simultaneous actuation of both valves 114A, 114B permits air or other substance residing in the annuluses 403, 404 to flow back and forth between the annuluses 403, 404 formed between first and second hose shrouds (hose jackets) 103, 102 and first and second hoses 103A, 102A as indicated by arrow 402. Arrow 402 indicates bidirectional flow between annuluses 403, 404. Arrow 402 indicates that bidirectional flow between the annuluses is possible, however, air or some other substance may flow in only one direction. Also, there may be no flow through the annular volume 130. Volume 130 may be full of air or other material acting as an insulator between the ambient environment outside hose shrouds 103, 102 and the hoses 103A, 102A, collars 115A, 115B, 112A, 112B, 111A, 111B, and coupling halves 110A, 110B.

FIG. 4B is an enlarged view 400B of a portion of FIG. 4A illustrating passageways 113P in the first main collar 112A and passageways 318P in the valve seat 114A communicating through a passageway 119 through the first valve 114A. Referring to FIG. 4B, arrows 402 represent the direction of the heat flow in chamber or volume 130. Volume 130 is then heated by an external heat source applied to the annular area between the first hose shroud 103 and the hose 103A. Alternatively, if heat is not applied to the annular area/volume between the first hose shroud 103 and the hose 103A, then the volume is simply filled with air. Air is a good thermal insulator and the volume between the first hose shroud 103 and the hose is insulated by the air therebetween. Additionally, and optionally, the inner portion of the hose shroud 103 is coated with a thermally resistive material to inhibit the flow of heat therethrough. A coating may be used as a thermally resistive material to inhibit the flow of heat therethrough.

The volume 130 between the coupling half covers 101A, 101B and the first and second main collars, 112A, 112B, the first and second valve seats 118A, 118B, the first and second spacers 116A, 116B, the first and second hose collars 111A, 111B and the first and second coupling halves 110A, 110B is also filled with air if no additional heat is added to the air. As such, as stated above air is a good thermal insulator and the volume 130 insulates the coupling halves 110A, 110B. Preferably, the coupling half covers 101A, 101B are made of nylon.

Referring to FIG. 1B, first hose collar 111A is illustrated securing hose 103A to an extension of coupling locking half 110A. Spacer 116A resides between first hose collar 111A and valve seat 118A. Valve seat 118A is urged against first main locking collar 112A by the first hose collar 111A and the spacer 116A. The valve seat 118A may also be affixed to the first main collar using screws, bolts or other fasteners. Seals (not shown) may be used between the valve seat 118A and the main locking collar 112A. See FIGS. 1E and 4B to view the unnumbered seals. Referring to FIGS. 1B and 1E, valve 114A is also shown in cross-section blocking the passageway 113P such that a heat source cannot communicate with valve seat 118A and the generally annularly shaped volume 130 between the locking coupling half 110A and the first coupling cover half 101A and the second coupling cover half 101B.

Still referring to FIG. 1B, second hose collar 111B is illustrated securing hose 102A to an extension of coupling locking half 110B. Spacer 116B resides between second hose collar 111B and second valve seat 118B. Second valve seat 118B is urged against second main locking collar 112B by the second hose collar 111B and the spacer 116B. Seals not shown in FIG. 1B may be used between the valve seat 118B and the main locking collar 112B Valve 114B is also shown in cross-section blocking the passageway 113B such that a heat source cannot communicate with valve seat 118B and the generally annularly shaped volume 130 between the locking coupling half 110B and the first coupling cover half 101A and the second coupling cover half 101B.

Still referring to FIG. 1B, tubes/pipes 105A, 105B, 105F, 105K, 105L, and 105M are illustrated in cross-section and reside between the first and second hoses 103A, 102A, and the first and second shrouds 103, 102, respectively.

Referring to FIGS. 1B, 1C, and 1D, the first coupling half 110A is connected to the second coupling half 110B thus connecting first hose 103A to the second hose 102A for communication of water or other fluid therebetween. The first coupling half 110A may be a STORZ coupling half or it may be a VITAULIC® coupling half. STORZ is a type of hose coupling invented by Carl August Guido Storz that connects using interlocking hooks and flanges. VITAULIC® is the registered trademark, United States Trademark Registration No. 4751126, of Victaulic Company, a Corporation of New Jersey, 4901 Kesslersville Road, Easton, Pa. 18040. There is no limitation in the type of hoses 103A, 102A that may be used in the structure. Hoses particularly those adapted to convey fluids used in the fracking process (hydraulic fracturing mining process) are specifically contemplated for the invention described herein.

FIG. 1C is a perspective view 100C of the first hose 103A, the first and second hose shrouds 103, 102, the first hose coupling half 110A, the second hose coupling half 110B, and the actuator system 104, 108A, 108B, 106, 107H. First hose collar 111A secures hose 103A to the first hose coupling half 110A. Second hose collar 111B secures hose 102A to the second hose coupling half 110B. First main collar 112A and second main collar 112B and respective shroud collars 115A, 115B are illustrated in FIG. 1C. Shroud collars 115A, 115B secure shrouds 103, 102 to respective main collars 112A, 112B. Separation of the hose shroud 103 from the hose 103A is maintained by tubes/pipes 105A, 105B and others. Separation of the hose shroud and the hose creates an annular volume therebetween which carries warmed or ambient air or is otherwise thermally insulated. For instance, the inner surface of the hose shroud is coated with a material which limits the thermal conductivity of the hose shroud.

FIG. 1D is a rear view 100D of the first 103 and second 102 hose shrouds, the first hose coupling half 110A, the second hose coupling half 110B, the actuator system 107H, 106, 108A, 108B, 104 including the catcher 106 which engages the actuator system. Preferably the catcher 106 is made of stainless steel, however, other materials may be used. The actuator system includes rail supports 108C, 108D, 108E which are affixed to the inner side of the coupling cover half 101A. Preferably, the rail supports are made of nylon, however, other materials may be used.

FIG. 2 is a view 200 of the inner portion of the coupling cover half 101A. Coupling cover half 101A is also viewed in FIGS. 1 and 1A. FIG. 2A is a view 200A of the outer portion of the coupling cover half 101A. Coupling cover half 101A is one-half of a cylinder. Three hinges 201 resides at the bottom of the coupling cover half 101A and mate with two hinges 201A at the bottom of the coupling cover half 101B. Coupling cover halves 101A, 101B are hinged together using the hinge pin 140 and hinges 201, 201A illustrated in FIGS. 2 and 2C such that the two coupling cover halves 101A, 101B open like a brief case. See FIG. 5 which illustrate the coupling cover halves 101A, 101B. In regard to FIG. 5, the assembly may alternatively be placed first in coupling cover half 101B. Preferably, the hinge is made of stainless steel, however, other materials may be used.

FIG. 2B is a view 200B of the outer portion of the coupling cover half 101B. FIG. 2C is a view 200C of the inner portion of the coupling cover half 101B. FIG. 2C illustrate seats 207, 206 which secure locking blocks 112C, 112F and prevent rotation of the main collars 112A, 112B and all components connected thereto. FIG. 2C also illustrates slots for shroud collars 115A, 115B, respectively.

Referring to FIG. 2, the inner side of the cover half 101A includes the first inner raised connection bar 204 and the second inner raised connection bar 205. First inner raised connection bar 204 is affixed to the rail support 108C and the second inner raised connection bar 205 is affixed to the rail support 108D. Clearances/recesses 204C, 204C in the raised connection bar 204 permit actuator rails 108A, 108B to move freely in the first inner raised connection bar in coupling cover half 101A without friction. Preferably, rails 108A, 108B are made of stainless steel. Rails 108A, 108B have a curvature which approximately matches the curvature of the valve seat as best viewed in FIG. 1F.

Clearances/recesses 205C, 205C permit actuator rails 108A, 108B to move freely within the second inner raised connection bar 205 in coupling cover half 101A without friction.

Still referring to FIG. 2, first recessed surface 202, second recessed surface 203, and third recessed surface 214 in cover half 101A enable movement of the actuator rails 108A, 108B without friction. Third recessed surface 214 enables movement of the actuator bar 104 between first and second positions without friction.

Actuator bar 104 is affixed to rails 108A, 108B in that the rails are press-fit into the actuator bar 104 as indicated by reference numerals 119A in FIG. 1H and as indicated by reference numerals 119A, 119B in FIG. 1D. Actuator rails 108A, 108B are stainless steel and they are press fit into slots 119A, 119B in actuator bar 104. Actuator rails 108A, 108B are arc-shaped as viewed in FIGS. 1C, 1D, 1F, 1G and 1H. Supports 108C, 108D and 108E are secured respectively to raised connection bars 204, 206, 224 of the coupling cover half 101A. Support 108C includes recesses 191A, 191B therein to allow actuator rails 108A, 108B to move therein without friction. Support 108D includes recesses 192A, 192B therein to allow actuator rails 108A, 108B to move therein without friction. Support 108E includes recesses 193A, 193B therein to allow actuator rails 108A, 108B to move therein without friction. The supports, when secured to the raised connection bars, form openings in which rails 108A, 108B reside and move as the actuator bar 104 is arcuately moved. Supports 108C, 108D and 108E are viewed in FIGS. 1B, 1C, 1D, 1F, and 1G. Raised connection bars 204, 205, 224 are viewed in FIG. 2.

FIG. 1E is an enlarged view 100E illustrating passageways 113P in the first main collar 112A and passageways 318P in the first valve seat 118A blocked by the first valve 114A. First valve 114A prohibits the aforesaid passageways 113P, 318P from communicating as illustrated in FIGS. 1B, 1E, 1F, 1G and 1H.

FIG. 1E illustrates the first position of the first valve 114A with respect to the first valve seat 118A. Unnumbered seals are illustrated between the valve seat 118A and the valve 114A. An unnumbered seal is illustrated between the main collar 112A and the valve 114A. An unnumbered seal is also illustrated between the main collar 112A and the guide 150A for the main collar 112A.

Still referring to FIG. 1E, hose locking collar 111A secures hose 103A to the hose coupling 110A. Hose locking collar 111A also secures spacer 116A against valve seat 118A which, in turn, secures the lip 301 of the first main locking collar 112A against guide 150A. Shroud locking collar 115A secures the hose shroud (hose jacket) 103A against the first main collar 112A and also secures the main collar 112A against leftward movement when viewing FIG. 1E.

FIG. 1F is a left side view 100F of the first hose 103A, the first valve seat 118A, the first valve 114A, and the actuator system including the catcher 106 which engages the actuator system. Catcher 106 includes a hook portion 106H which engages bar actuation linkage 107L when the first valve 114A moves from the first position (closed position) as shown in FIG. 1F to the second position (open position) as shown in FIG. 1I. Hook 106H engages bar actuation linkage 107L and urges the actuator linkage including actuator rails 108A, 108B rightwardly rotating the first valve 114A clockwise with respect to the valve seat 118A as indicated by arrow 160. Handle 107H pivots about pivot 107P and catcher pivots about pivot 106P. As handle 107H rotates in a clockwise direction as indicated by arrow 161, hook 106H urges the actuator linkage 107L, 108A, 108B and the actuator bar 104 arcuately in the clockwise direction indicated by arrow 160 until guide pins 121 engage the second end 120L of slot 120. See FIG. 1I. Preferably, guide pins 121 are made of aluminum, however, other materials may be used.

FIG. 1G is another perspective view 100G of the first 103A and second 102A hoses, the first hose coupling half 110A, the second hose coupling half 110B, the first valve seat 118A, the first valve 114A, the second valve seat 118A, and the actuator system including the catcher 106 which engages the actuator system. FIG. 1G, like FIG. 1D, illustrates: the first and second coupling halves 110A, 110B; the first and second hose collars 111A, 111B; the first and second valve seats 118A, 118B; the first and second valves 114A, 114B; the first rail support 108C, the second rail support 108D and the third rail support 108E; the actuator bar 104, the actuator handle 107H, and the actuator catcher 106.

FIG. 1H is an enlarged perspective view 100H of the first hose 103A, the first valve seat 118A, the first valve 114A, the actuator system, and the catcher 106 which engages the actuator system. Slots 120 have a first end 120F and a second end 120L. FIG. 1H illustrates the bar actuator 104 in the first position with the guide pin 121 engaging the first ends 120F of the slots 120. As stated previously, actuator bar 204 is rotated in a clockwise direction as the actuator bar moves from the first position to the second position as illustrated in FIG. 1I. FIG. 1H illustrates rail 108A press-fit as indicated by reference numeral 119A. Reference numerals 191A, 191B are used to indicate slots in the actuator bar 104 into which rails 108A, 108B are press fit. Rails 108A, 108B are made of stainless steel and are press-fit into actuator bar 104 such that movement of the rails results in movement of the bar actuator 104 including the extensions 104E, 104F. Extensions 104E, 104F engage protrusions 114Y, 114L when first and second valves 114A, 114B are rotated to their second positions permitting communication through respective passageways 113P, 113B of first and second main collars 112A, 112B, through respective passageways 119, 119P of first and second valves 114A, 114B, and through respective passageways 319P, 418P of first and second valve seats 118A, 118B. See FIG. 4A which illustrates flow arrow 402. Flow through passageways 113P, 119, 318P of the first main collar 112A, the first valve 114A and the first valve seat 118A, respectively, and flow through passageways 113B, 119P. 418P of the second main collar 112B, the second valve 114B and the second valve seat 118B are illustrated in FIG. 4A.

FIG. 1I is a left side view 100I of the first hose 103A, the first valve seat 118A, the first valve 114A, and the actuator system including the catcher 106 which engages the actuator system wherein the first valve 114A is in the second position. Second end 120L of slot 120 abuts guide pins 121 in the second position. In the second position, the actuator bar extensions 104E, 104Y rotate the valves 114A, 114B until the second end portions of the slots engage the guide pins 121. FIG. 1F illustrates the closed position (first position) of first valve 114A along with the closed position of the bar actuation linkage 107L, actuation rail 108A and actuator bar extension 104E. Actuation rail 108A is arcuately shaped and is guided by: bar supports 108C in combination with the raised connection bar 204 of cover half 101A; bar support 108D in combination with the raised connection bar 205 of cover half 101A; and, bar support 108E in combination with the raised connection bar 214 of cover half 101A. Rails 108A, 108B are urged through the guides formed by supports 108C, 108D and 108E and the raised connection bars 204, 205 and 214 by the hook 106H of the catcher 106 as the handle 107H is pivoted in a clockwise direction as set forth in FIG. 1F. Handle 107H is rotated clockwise and the rails 108A, 108B are urged rightwardly until handle 107H is clamped into a locked position. The coupling half covers 101A, 101B are opened by lifting up on the handle 107H and rotatably moving it way from plate 109 thus unclamping the handle. Then, hook 106H is released from the bar actuation linkage 107L enabling the coupling cover halves 101A, 101B to be opened as illustrated in FIG. 5. Pivoting handle 107H is affixed to plate 109 which is affixed to the depressed surface 106D in coupling cover half 101B.

FIG. 5 is a perspective view 500 of the coupling cover halves 101A, 101B with the placement of the coupling halves 110A, 110B, hoses 103A, 102A, hose shrouds 103, 102, collars 112A, 112B and other components therein and before the coupling cover halves are closed. Actuation bar 104 together with extensions 104E, 104F are illustrated in FIG. 1D. Extensions 104E, 104Y are separated a specific distance from each other and engage protrusions 114X, 114Y and 114K, 114L, respectively. An opening between shoulders 118C and 118Y in valve seat 118A enable extension 104E to engage protrusions 114X and 114Y of valve 114A to move back and forth between first and second positions.

Still referring to FIG. 1D, the length of the actuation bar 104 controls the spacing of the assembly. Hose coupling halves 110A, 110B are coupled together. Hoses 103A, 102A are affixed to the hose coupling halves 110A, 110B with hose collars 111A, 111B, respectively. Unnumbered gaps reside between hose collars 111A, 111B and hose coupling halves 110A, 110B, respectively. Hose collars 111A, 111B are affixed against spacers 116A, 116B forcibly urging first and second valve seats 118A, 118B against first and second collars, 112A, 112B. First and second valve seats 114A, 114B reside between the respective valve seats and main collars. Main collars 112A, 112B interfit guide blocks 150A, 150B within coupling halves 101A, 101B and prevent movement of the main collars with respect to the coupling halves 101A, 101B.

Hose shroud collars 115A, 115B secure the hose shrouds (outer jackets) to the main collars 112A, 112B. Main collars 112A, 112B include a reduced diameter portion 302R which include a series of ridges to better grip the hose shrouds. Hose shroud collars 115A, 115B engage main collars 112A, 112B and reside in slots 151A, 151B. As previously stated, main collars 112A, 112B include locking blocks 112C, 112D which are keyed/locked in seats 207, 206, respectively. See FIG. 5. As such, the coupling half assemblies are secured against rotation. Coupling half assemblies mean all components with the coupling halves.

As stated previously, there are two identical coupling halves, two identical main collars, two identical valve seats, two identical valves, two identical hose shrouds, and two identical hoses in the assembly. Additionally, both coupling half assemblies operate identically as described hereinabove.

### REFERENCE NUMERALS

100 perspective view of thermal hose coupling and hose
100A left side view of the thermal hose coupling and hose
100B cross-sectional view of the thermal hose coupling and hose taken along the lines 1C-1C of FIG. 1
100C cross sectional view taken along the lines 1C-1C of FIG. 1
100D rear view of the first and second hoses, the first hose coupling half, the second hose coupling half, the actuator system, and the catcher which engages the actuator system.
100E enlarged portion of the cross-sectional view of FIG. 1B illustrating passageways 113P and passageways 119 being blocked by valve 114A
100F left side view of the structure in FIG. 1E
100G another perspective view of the first and second hoses, the first hose coupling half, the second hose coupling half, the first valve seat, the first valve, the second valve seat, the actuator system, and the catcher which engages the actuator system.
100H an enlarged perspective view of the first hose, the first valve seat, the first valve, the actuator system, and the catcher which engages the actuator system.
101A coupling/housing cover half
101B coupling/housing cover half
101C seam between cover half 101A and cover half 101B
101D seam between cover half 101A and cover half 101B
102 hose shroud
102A second hose
103 hose shroud (hose jacket)
103A first hose
104 actuator bar
104E extension for engagement with valve protrusions
105A pipe support between hose shroud and hose 103A
105B pipe support between hose shroud and hose 103A
105C pipe support between hose shroud and hose 103A
105D pipe support between hose shroud and hose 103A
105E pipe support between hose shroud and hose 103A
105F pipe support between hose shroud and hose 103A
106 catcher which extends and retracts closing/opening bar actuation linkage 107L
106D cavity for catcher
106H hook on catcher 106
106P pivot of catcher 106 with respect to handle 107H
107L bar actuation linkage
107H pivoting handle
107P pivot of handle 107H
108A actuator rail
108B actuator rail
108C support affixed to housing cover half 101A
108D support affixed to housing cover half 101A
109 plate affixed to coupling cover half 101B
110A first hose coupling half
110B second hose coupling half
111A first hose collar
111B second hose collar
112A first main collar
112B second main collar
112C first main collar 112A locking block
112D second main collar 112 locking block
1121 inner cylindrical surface of first main collar 112A
113P passageways through main collar 112A
113B passageways through main collar 112B
114A first valve
114B second valve
114C protrusion on second valve 114B
114D protrusion on second valve 114B
114X protrusion on first valve 114A
114Y protrusion on first valve 114A
114K protrusion on second valve 114B
114L protrusion on second valve 114B
115A first shroud collar
115B second shroud collar
116A spacer between hose collar 111A and first valve 118A
116B spacer between hose collar 111B and second valve 118B
118A first valve seat
118B second valve seat
118X first shoulder on valve seat
119 passageway in valve 114A
119P passageway in valve 114B
119A force-fit connection between actuator rail 108A and actuator bar 104
119B force-fit connection between actuator rail 108B and actuator bar 104
120 slot in valve 114A
120F first end of slot 120 which pin engages in the first position
120L second end of slot 120 which pin engages in the second position
121 guide pin mounted in valve seat 118A which resides in slot 120 in valve 114A
130 chamber within housing 101
140 hinge rod
150A guide for main collar
150B guide for main collar
151A recess for shroud collar 112A
151B recess for shroud collar 112B
160 arrow indicating arcuate motion of the first valve 114A between first and second positions
161 arrow indicating motion of the pivoting handle 107H
191A recess in support 108C
191B recess in support 108C
192A recess in support 108D
192B recess in support 108D
193A recess in support 108E
193B recess in support 108E
200 is a view of the inner portion of cover half 101A
200A is a view of the outer portion of cover half 101A
200B is a view of the outer portion of cover half 101B
200C is a view of the inner portion of cover half 101B
201 hinge in coupling cover half 101A
201A hinge in coupling cover half 101B
202 first recessed surface in cover half 101A
203 second recessed surface in cover half 101A
204 first inner raised connection bar in cover half 101A
204C clearances/recesses in first inner raised connection bar in cover half 101A
205 second inner raised connection bar in cover half 101A
205C clearances/recesses in second inner raised connection bar in cover half 101A
206 seat for first main collar 112A locking block 112C
207 seat for first main collar 112B locking block 112D
208 seat for first shroud collar 115A
209 seat for second shroud collar 115B
214 third recessed surface in cover half 101A
300 perspective view of the first main collar 112A
300A cross-sectional view of the first main collar taken along the lines 3A-3A of FIG. 3.
300B perspective view of the valve 114A
300D exploded perspective view of the first main collar 112A, first valve 114A and the first valve seat 114A
301 lip of the first main collar 112A
301A face of the lip which engages the first main valve 112A
302L larger diameter surface 302L
302R reduced diameter surface of the main collar valve 112A
302S shoulder residing between reduced diameter surface 302R and larger diameter surface 302L
318P passageways through valve seat 118A
318R recessed portion of valve seat 118A which slidingly engages rotatable valve 114A
318S pin socket for guide pin 121
400 a perspective view of the first and second hoses within the hose coupling cover with the pivoting handle and the catcher latched
400A a cross-sectional view taken along the lines 4A-4A of FIG. 4
400B an enlargement of a portion of FIG. 4A illustrating passageways 113P in the first main collar 112A, passageways 119 in the valve seat 118A communicating through passageways 119 through the first valve 114A.

The invention has been set forth herein by way of example only. Those skilled in the art will recognize that changes may be made to the example set forth herein and that those changes are contemplated by the claims that follow hereinafter.

1. A hose coupling cover, comprising:
a first main collar, said first main collar includes a passageway therethrough;
a first valve seat, said first valve seat includes a first passageway therethrough;
a first valve, said first valve includes a first passageway therethrough;
said first passageway of said first main collar aligned with said first passageway of said first valve seat;
an actuator, said actuator engages said first valve and moves said first valve with respect to said first valve seat between a first position and a second position;
in said first position, said first passageway of said first valve is not aligned with said first passageway of said first main collar and said first passageway of said first valve seat;
a housing;
a first hose coupling half;
said first hose coupling half, said first main collar, said first valve, and said first valve seat reside within said housing;
said housing circumferentially extends about said first hose coupling half forming an annular space therebetween;
said first passageway in said first valve seat communicates with said annular space; and,
in said second position, said first passageway of said first valve is aligned with said first passageway of said first main collar, and said first passageway of said first valve seat permitting communication between said annular space and said first passageway of said first main collar.

2. A hose coupling cover as claimed in claim 1, further comprising:
said first passageway of said first main collar communicates with a heat source.

3. A hose coupling cover as claimed in claim 1, further comprising:
a first hose, said first hose conveys fluid, said first hose affixed to said first hose coupling half;
a first outer shroud;
said first outer shroud affixed between a first shroud collar and said first main collar; and,
said first passageway of said first main collar communicates with an annulus formed by said first hose and said first outer shroud.

4. A hose coupling cover as claimed in claim 3 wherein a first hose collar affixes said first hose to said first hose coupling and a first shroud collar affixes said first outer shroud to said first main collar.

5. A hose coupling cover as claimed in claim 4 wherein said housing includes a first half and a second half.

6. A hose coupling cover as claimed in claim 1, further comprising:
a second main collar, said second main collar includes a passageway therethrough;
a second valve seat, said second valve seat includes a second passageway therethrough;
a second valve, said second valve includes a first passageway therethrough;
said first passageway of said second main collar aligned with said first passageway of said second valve seat;
an actuator, said actuator engages said second valve and moves said second valve with respect to said second valve seat between a first position and a second position;
in said first position, said first passageway of said second valve is not aligned with said first passageway of said first main collar and said first passageway of said second valve seat;
a housing;
a second hose coupling half;
said second hose coupling half, said second main collar, said second valve, and said second valve seat reside within said housing;
said housing circumferentially extends about said second hose coupling half forming an annular space therebetween;
said first passageway in said second valve seat communicates with said annular space; and,
in said second position, said first passageway of said second valve is aligned with said first passageway of said second main collar, and said first passageway of said second valve seat permitting communication between said annular space and said first passageway of said second main coupling.

7. A hose coupling cover as claimed in claim 1, further comprising:
said housing includes a first seat;
said first main collar includes a locking block;
said first main collar locking block interfits said first seat of said housing.

8. A hose coupling cover as claimed in claim 6, further comprising:
said housing includes a first seat and a second seat;
said first main collar includes a locking block;
said second main collar includes a locking block;
said first main collar locking block interfits said first seat of said housing and said second main collar locking block interfits said second seat of said housing preventing rotation of said first main collar and said second main collar with respect to said housing.

9. A hose coupling cover as claimed in claim 3, further comprising:
wherein a first hose collar affixes said first hose to said first hose coupling and a first shroud collar affixes said first outer shroud to said first main collar;
a first spacer;
said first hose collar engages said first spacer urging said first spacer into engagement with said first valve seat;
said first valve seat engages said first main collar; and,
said first main collar engages said housing preventing movement of said first main collar with respect to said housing.

10. A hose coupling cover, comprising:
a first coupling cover half and a second coupling cover half, said first coupling cover half and said second coupling cover half being rotatably connected to each other such that said first and said second coupling cover halves are opened and closed;
said first and said second coupling cover halves adapted to include a first hose coupling half and a second hose coupling half, said first hose coupling half and said second hose coupling half being affixed to each other;
means for affixing a first hose to said first coupling half and means for affixing a second hose to said second coupling half;
a first main collar and a second main collar, said first hose resides partially within said first main collar and said second hose resides partially within said second main collar;
a first hose shroud and a second hose shroud, said first hose shroud affixed to said first main collar and said second hose shroud affixed to said second main collar;
a first valve means and a first seat means;
a second valve means and a second seat means;
said first valve means movable between a first, closed position and a second, open position;
said second valve means movable between a first, closed position and a second, open position;
actuator means for moving: said first valve means with respect to said first seat means between said first, closed position and said second, open position; and, said second valve means with respect to said second seat means between said first, closed position and said second, open position;
said first main collar includes a first passageway therethrough and said second main collar includes a first passageway therethrough;
said first valve means includes a first passageway therethrough and said second valve means includes a first passageway therethrough;
said first seat means includes a first passageway therethrough and said second seat means includes a first passageway therethrough;
said first passageway of said first main collar aligned with said first passageway of said first valve seat means;
said first passageway of said second main collar aligned with said first passageway of said second valve seat means;
when said actuator moves said first valve means to said second position with respect to said first seat means, said first passageway of said first main collar, said first passageway of said first valve means, and said first passageway of said first seat means are aligned; and,
when said actuator moves said second valve means to said second position with respect to said second seat means, said first passageway of said second main collar, said first passageway of said second valve means, and said second passageway of said first seat means are aligned.

11. A hose coupling cover as claimed in claim 10, further comprising:
said first passageway of said first main collar communicates with a heat source.

12. A hose coupling cover as claimed in claim 10, further comprising:
said first outer shroud affixed between a first shroud collar and said first main collar; and,
said first passageway of said first main collar communicates with an annulus formed by said first hose and said first outer shroud.

13. A hose coupling cover as claimed in claim 10 wherein a first hose collar affixes said first hose to said first hose coupling and a first shroud collar affixes said first outer shroud to said first main collar.

14. A hose coupling cover, comprising:
a housing;
said housing is generally cylindrically shaped;
said housing includes a first coupling cover half and a second coupling cover half;
said first coupling cover half and said second coupling cover half being rotatably interconnected;
said first coupling cover half and said second coupling cover half being openable and closable with respect to each other;
a first hose and a second hose;
said first hose affixed to a first hose coupling half and a second hose affixed to a second hose coupling half;
a first hose coupling half and a second hose coupling half connected together;
said first hose coupling half and said second hose coupling half reside with said housing;
a first outer shroud and a second outer shroud;
said first outer shroud spaced apart and surrounding said first hose forming a first annulus therebetween;
said second outer shroud spaced apart and surrounding said second hose forming a second annulus therebetween; and,
said cylindrically shaped housing spaced apart and surrounding said first hose coupling half and said second hose coupling half forming housing annulus therebetween;

15. A hose coupling cover as claimed in claim 14, further comprising:
a first valve between said first annulus and said housing annulus;
a second valve between said second annulus and said housing annulus;
said first annulus communicating with said housing annulus when said first valve is open; and,
said second annulus communicating with said housing annulus when said second valve is open.

16. A hose coupling cover as claimed in claim 14, further comprising:
a first valve between said first annulus and said housing annulus;
a second valve between said second annulus and said housing annulus;
said first annulus does not communicate with said housing annulus when said first valve is closed; and,
said second annulus does not communicate with said housing annulus when said second valve is closed.

17. A hose coupling cover as claimed in claim 15, wherein said first valve includes a rotary valve and a stationary valve seat and said second valve includes a rotary valve and station valve seat.

18. A hose coupling cover as claimed in claim 16, wherein said first valve includes a rotary valve and a stationary valve seat and said second valve includes a rotary valve and station valve seat.

19. A hose coupling protection method, comprising the steps of:
inserting a first hose through a first main collar, a first valve, a first valve seat, a first spacer and over an end of a first hose coupling half;
positioning said first main collar against a first coupling cover half or a second coupling half;
securing said first hose to said end of said first hose coupling half and urging said spacer and said valve seat against said first main collar using a first hose collar;
positioning a first hose shroud within a first coupling cover half and over said first main collar securing said first hose shroud to said main first collar using a first shroud collar;
forming a first annulus between said first hose shroud and said first hose;
closing said first coupling cover half and said second coupling half together forming a housing annulus between said first hose coupling half and said first and second coupling cover halves; and,
enabling insulating communication between said first annulus and said housing annulus.

20. A hose coupling protection method as claimed in claim 19, further comprising the steps of:
inserting a second hose through a second main collar, a second valve, a second valve seat, a second spacer and over an end of a second hose coupling half;
positioning said second main collar against a first coupling cover half or a second coupling half;
securing said second hose to said end of said second hose coupling half and urging said second spacer and said second valve seat against said second main collar using a second hose collar;
positioning a second hose shroud within a first coupling cover half and over said second main collar securing said second hose shroud to said second main collar using a second shroud collar;
forming a second annulus between said second hose shroud and said second hose;
closing said first coupling cover half and said second coupling half together forming a housing annulus between said second hose coupling half and said first and second coupling cover halves; and,
enabling insulating communication between said second annulus and said housing annulus.

21. A hose coupling cover in combination with a first hose shroud and a second hose shroud, comprising:
a first hose and a second hose:
a hose coupling:
said first hose connected to said coupling and said second hose connected to said coupling:
a coupling cover:
said first hose shroud connected with said coupling cover;
said second hose shroud connected with said coupling cover;
said first hose shroud spaced apart from said first hose forming a first annulus;
said second hose shroud spaced apart from said second hose forming a second annulus:
said hose coupling cover spaced apart from said hose coupling forming a housing annulus:
a first main collar intermediate said first annulus and said housing annulus;
a second main collar intermediate said second annulus and said housing annulus;
said first main collar includes a passageway interconnecting said first annulus and said housing annulus enabling fluidic communication therebetween;
said second main collar include a passageway interconnection said second annulus and said housing annulus enabling fluidic communication therebetween; and,
said first annulus, said second annulus and said housing annulus provide insulation of said first hose, said second hose and said hose coupling.

22. A hose coupling cover in combination with a first hose shroud and a second hose shroud as claimed in claim 21, further comprising:
a first valve opening and closing said passageway in said first main collar; and,
a second valve opening and closing said passageway in said second main collar.

23. A hose coupling cover in combination with a first hose shroud and a second hose shroud as claimed in claim 21, further comprising:
said first annulus, said second annulus and said housing annulus include air.

24. A hose coupling cover in combination with a first hose shroud and a second hose shroud as claimed in claim 23, wherein said air may be heated.

25. A hose coupling cover in combination with a first hose shroud and a second hose shroud as claimed in claim 21, further comprising:
said first annulus, said second annulus and said housing annulus include a fluid or a gas.

26. A hose coupling cover in combination with a first hose shroud and a second hose shroud as claimed in claim 25, wherein said fluid or gas may be heated.

27. An insulated hose, comprising:
a hose and a hose shroud;
said hose and said hose shroud are concentric;
said hose resides within said hose shroud:
said hose shroud spaced apart from said hose and separated therefrom forming an annulus therebetween;
a plurality of spacers, said plurality of spacers reside between said hose shroud and said hose;
a heat source, said heat source supplies heat to said annulus.
